(19) United States
(12) Patent Application Publication
(10) Pub. No.: US 2011/0273628 A1
(43) Pub. Date: Nov. 10, 2011

(54) OPTICAL DEVICE AND PROJECTION SYSTEM

(75) Inventors: Chi-Yu Lee, Hsin-Chu (TW); Kuo-Yuan Liang, Hsin-Chu (TW); Wei-Lun Hung, Hsin-Chu (TW); Chun-Chin Chang, Hsin-Chu (TW)

(73) Assignee: CORETRONIC CORPORATION, Hsin-Chu (TW)

(21) Appl. No.: 12/908,894

(22) Filed: Oct. 21, 2010

(30) Foreign Application Priority Data
May 10, 2010 (CN) 201010180468.5

(51) Int. Cl. H04N 9/31; G06F 3/033

(52) U.S. Cl. 348/744; 345/166; 348/E09.025

(57) ABSTRACT

An optical device for controlling a projector is provided. The projector projects a projection image. The optical device includes a receiving module, a mode switching module, and a transmission module. The receiving module is capable of sensing a reflected signal of the projection image. The mode switching module is capable of generating a control signal to control the projector to switch from a first mode to a second mode. The transmission module is capable of transmitting the reflected signal and the control signal to the projector. A projection system including the projector and the optical device is also provided.

### CROSS-REFERENCE TO RELATED APPLICATION

This application claims the priority benefit of China application serial no. 201010180468.5, filed on May 10, 2010. The entirety of the above-mentioned patent application is hereby incorporated by reference herein and made a part of this specification.

### BACKGROUND OF THE INVENTION

1. Field of the Invention

The invention generally relates to an optical device and a projection system, and more particularly, to an optical device and a projection system capable of controlling a projector.

2. Description of Related Art

FIG. 1 is a diagram of a conventional projection system 100. Referring to FIG. 1, the projection system 100 has a projector 110, a personal computer (PC) 120, and a mouse 140. The projector 110 is connected to the PC 120 through a transmission cable 122, and the mouse 140 is connected to the PC 120 through a signal cable 124. The PC 120 transmits an image signal to the projector 110 such that the projector 110 projects a projection image 130. The mouse 140 operated by a user generates a corresponding position signal to control the movement of a cursor 150 in the projection image 130.

From the user's viewpoint, the relative position and arrangement of the projector 110, the PC 120, and the mouse 140 are limited by the lengths of the transmission cable 122 and the signal cable 124. Thus, inconvenience in using the projection system 100 may be caused if the transmission cable 122 and the signal cable 124 are too short. On the other hand, if the user needs to operate the mouse 140 to control the cursor 150 when the user gives a briefing, the user sits or stands in front of the PC 120. However, this makes it difficult for the user to closely interact with other participants.

Additionally, an image projection system is disclosed by Miyashita in U.S. Pat. No. 7,059,724. In this disclosure, the operation of a projector is controlled by using a remote control. The remote control has a trackball means which allows a user to control the cursor movement in the image. However, it is difficult for the user to operate the trackball means and buttons of the remote control at the same time with a single hand.

### SUMMARY OF THE INVENTION

Accordingly, the invention is directed to an optical device for controlling a projector, wherein the optical device senses an image projected by the projector and controls the movement of a cursor in the projected image in a wireless manner.

The invention is directed to a projection system having a projector and an optical device, wherein the optical device senses an image projected by the projector and controls the movement of a cursor in the projected image in a wireless manner so that a user may conveniently give a briefing.

Additional aspects and advantages of the invention will be set forth in part in following description.

According to an embodiment of the invention, an optical device for controlling a projector is provided, wherein the projector projects a projection image. The optical device includes a receiving module, a mode switching module, and a transmission module. The receiving module senses a reflected signal of the projection image. The mode switching module generates a control signal to control the projector to switch from a first mode to a second mode.

The transmission module transmits the reflected signal sensed by the receiving module and the control signal generated by the mode switching module to the projector.

According to an embodiment of the invention, a projection system including a projector and an optical device is provided. The projector projects a projection image. The optical device includes a receiving module, a mode switching module, and a transmission module. The receiving module senses a reflected signal of the projection image. The mode switching module generates a control signal to control the projector to switch from a first mode to a second mode.

The transmission module transmits the reflected signal sensed by the receiving module and the control signal to the projector.

According to an embodiment of the invention, the mode switching module includes a plurality of buttons, and one of the buttons generates the control signal.

According to an embodiment of the invention, the projector switches from the first mode to the second mode when one or more of the buttons are pressed for a predetermined time.

According to an embodiment of the invention, the projector switches from the first mode to the second mode when at least two of the buttons are simultaneously pressed.

According to an embodiment of the invention, the optical device is used as a mouse when the projector is in the first mode and as a remote control when the projector is in the second mode.

According to an embodiment of the invention, the projector receives an image signal from a data source, combines an identification signal into the image signal to generate a projection signal, and projects the projection image according to the projection signal.

According to an embodiment of the invention, the receiving module senses the reflected signal of the projection image and outputs a detection signal related to the reflected signal. The transmission module transmits the detection signal to the projector in a wireless manner. The projector determines the position pointed by the receiving module in the projection image according to the detection signal so as to output a position information to the data source.

According to an embodiment of the invention, the optical device further includes an analog-to-digital converter (ADC), and the receiving module includes a photosensitive component and an analog amplifier. The photosensitive component senses the reflected signal and outputs a sensed signal. The analog amplifier is coupled to the photosensitive component, and which amplifies the sensed signal to generate an amplified signal. The ADC is coupled to the analog amplifier, and which converts the amplified signal into the detection signal. The transmission module is coupled to the ADC, and which transmits the detection signal to the projector in a wireless manner.

According to an embodiment of the invention, the photosensitive component is a photodiode.

According to an embodiment of the invention, the projector controls the brightness of the projection image according to the detection signal.

According to an embodiment of the invention, the projector includes a first wireless transmission module, an ADC, a processor, a signal processing module, a projection module, and a transmission interface. The first wireless transmission module receives the detection signal from the optical device. The ADC is coupled to the first wireless transmission module, and which converts the detection signal into a digital signal. The processor is coupled to the ADC, and which processes the image signal and generates the position information according to the digital signal. The signal processing module is coupled to the processor, and which combines the identification signal into the image signal to generate the projection signal. The projection module is coupled to the signal processing module, and which projects the projection image according to the projection signal. The transmission interface is coupled to the processor, and which transmits the position information to the data source through a transmission cable.

According to an embodiment of the invention, the projector includes a first wireless transmission module, an ADC, a processor, a signal processing module, a projection module, and a second wireless transmission module. The first wireless transmission module receives the detection signal from the optical device. The ADC is coupled to the first wireless transmission module, and which converts the detection signal into a digital signal. The processor is coupled to the ADC, and which processes the image signal and generates the position information according to the digital signal. The signal processing module is coupled to the processor, and which combines the identification signal into the image signal to generate the projection signal. The projection module is coupled to the signal processing module, and which projects the projection image according to the projection signal. The second wireless transmission module is coupled to the processor, and which transmits the position information to the data source in a wireless manner and receives the image signal from the data source.

As described above, an embodiment of the invention has at least one of following advantages. The optical device in an embodiment of the invention controls a projector. The optical device senses an image projected by the projector and transmits the detection result to the projector, so that the projector may determine the position pointed by the optical device in the projected image according to the detection result. Thus, a cursor in the projection image moves along with different position pointed by the optical device in the projection image. In addition, the projection system in an embodiment of the invention includes a projector and an optical device. The optical device senses an image projected by the projector and transmits the detection result to the projector, so that the projector may determine the position pointed by the optical device in the projection image according to the detection result. Thus, a user may move a cursor in the projected image in a wireless manner, which makes it very convenient for the user to give a briefing. The optical device has a mode switching module. The mode switching module generates a control signal to control the projector to switch from a first mode to a second mode. The optical device may be used as either a mouse or a remote control according to the mode of the projector.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional projection system.

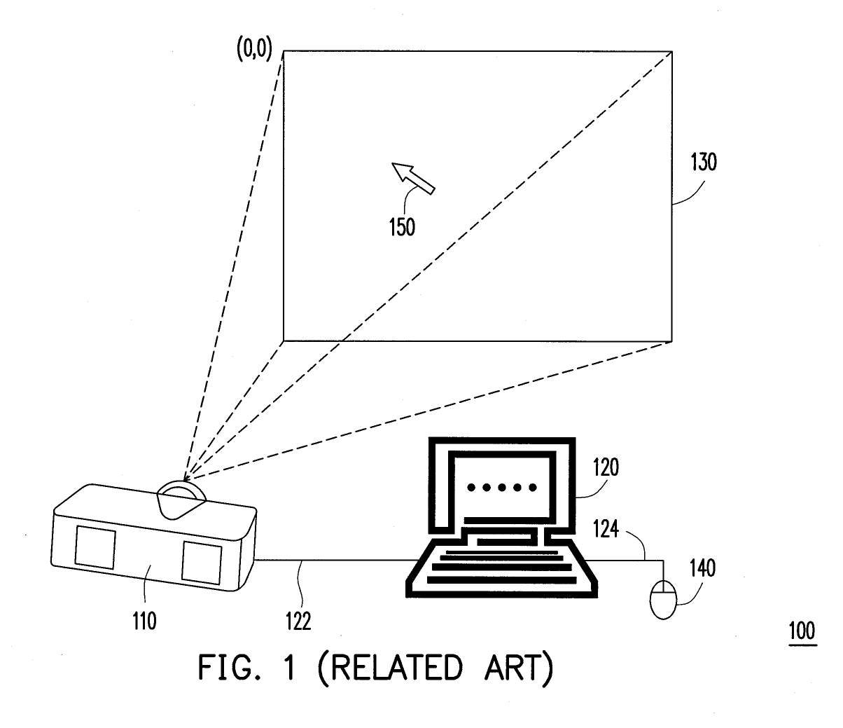

FIG. 2 is a diagram of a projection system according to an embodiment of the invention.

FIG. 3 is a schematic block diagram of the projection system in FIG. 2.

FIG. 4 is a diagram of a projection image when a function corresponding to a third button is set according to an embodiment of the invention.

FIG. 5 is a diagram of a projection system according to an embodiment of the invention.

FIG. 6 is a schematic block diagram of the projection system in FIG. 5.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

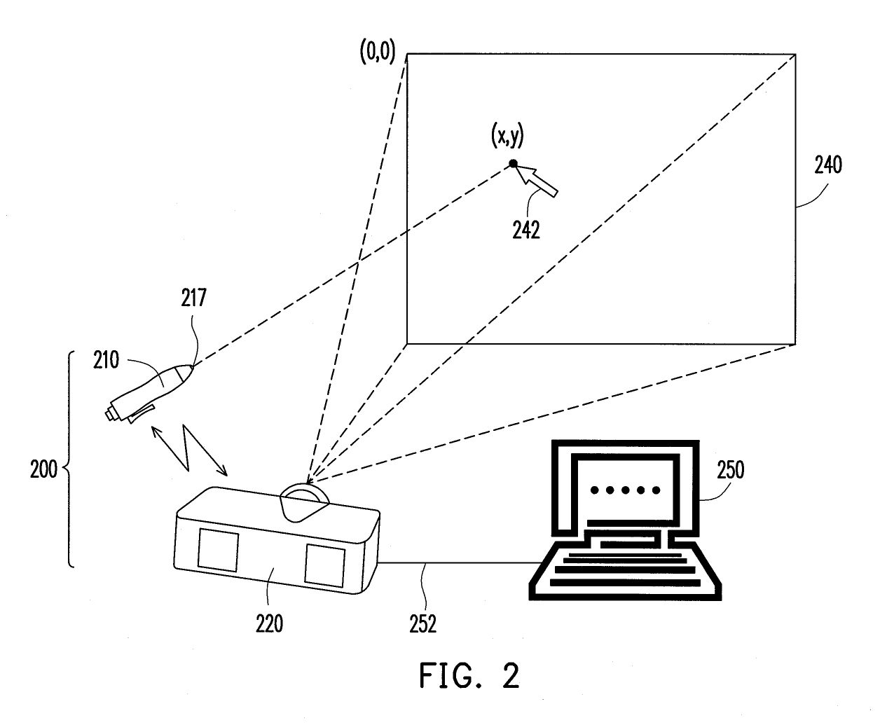

Referring to FIG. 2, the projection system 200 in an embodiment of the invention has an optical device 210. The optical device 210 controls a projector 220. The projector 220 projects a projection image 240 according to a signal received from a data source 250. The optical device 210 senses the projection image 240 and transmits the detection result to the projector 220 in a wireless manner. The projector 220 determines a position (x, y) appointed by the optical device 210 in the projection image 240 according to the detection result of the optical device 210 and outputs a position information to the data source 250. Thus, the data source 250 may control the movement of a cursor 242 in the projection image 240 according to the position information.

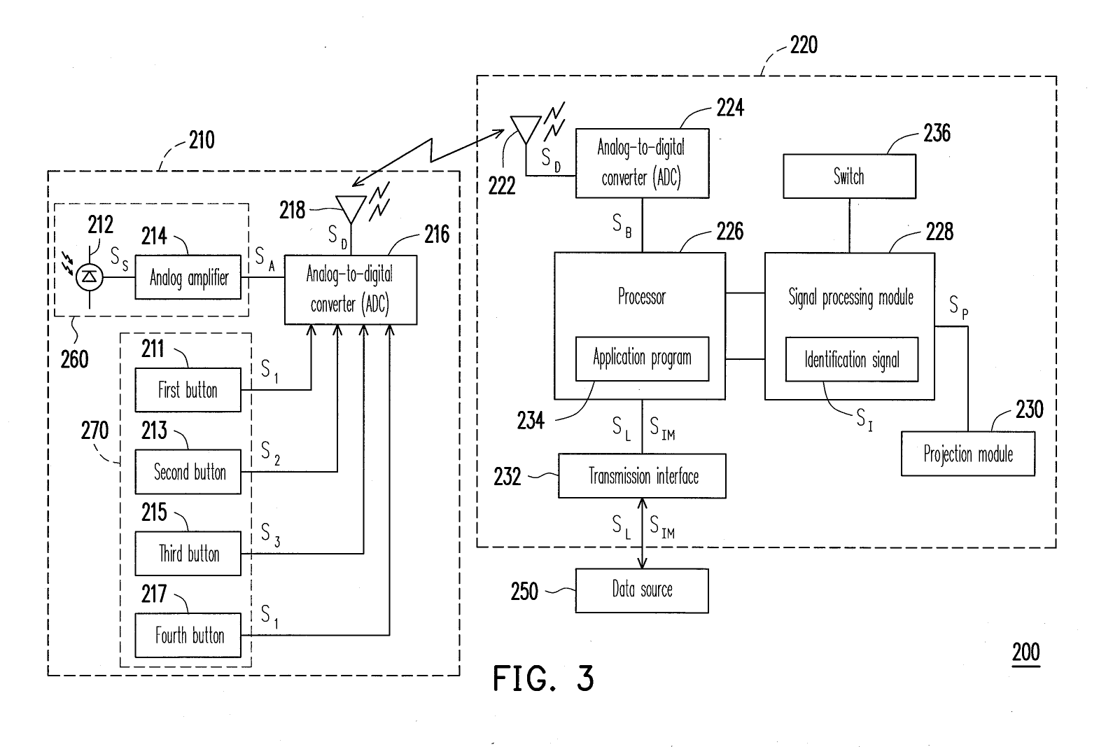

FIG. 3 is a schematic block diagram of the projection system 200 in FIG. 2. In the embodiment, the data source 250 is a personal computer (PC). However, the invention is not limited thereto. For example, the data source 250 may also be a DVD player, a television set, a personal digital assistant (PDA), or a mobile phone. Referring to FIGS. 2 and 3, the projector 220 is connected to the data source 250 by a transmission cable 252 to receive an image signal S_{IM} from the data source 250 through the transmission cable 252. After that, the projector 220 combines an identification signal S_{I} into the image signal S_{SI} to generate a projection signal S_{P}. The projector 220 projects the projection image 240 according to the projection signal S_{P}. The identification signal S_{I} carries coordinates information such that the optical device 210 may generate a corresponding detection signal S_{D} by detecting the projection image 240.

The optical device 210 has a receiving module 260, a mode switching module 270, and a transmission module 218. The receiving module 260 senses a reflected signal coming from a position (x, y) on the projection image 240, wherein the reflected signal contains information of the identification signal S_{I}. The mode switching module 270 generates one or more control signal S₁, control signal S₂, and/or control signal S₃ to control the projector 220 to switch from a first mode to a second mode (for example, from a mouse mode to a remote control mode). The transmission module 218 transmits the reflected signal and the control signal S₁, S₂, and/or S₃ to the projector 220.

The receiving module 260 further has a photosensitive component 212 and an analog amplifier 214. The photosensitive component 212 senses a reflected signal from the position (x, y) of the projection image 240 and outputs a sensing signal S. The analog amplifier 214 is coupled to the photosensitive component 212, and which amplifies the sensing signal S_{S} to generate an amplified signal S_{A}. In an embodiment of the invention, the photosensitive component 212 is a photodiode for sensing light from the position (x, y). However, the invention is not limited thereto, and the photosensitive component 212 may also be a charge coupled device (CCD) or a complementary metal oxide semiconductor (CMOS) sensor.

After the receiving module 260 of the optical device 210 senses the projection image 240, the optical device 210 outputs a detection signal S_{D} related to the reflected signal to the projector 220 in a wireless manner. The projector 220 determines the position (x, y) pointed by the optical device 210 in the projection image 240 according to the detection signal S_{D} and outputs a position information S_{L} to the data source 250. In the embodiment, the projector 220 transmits the position information S_{L} to the data source 250 through the transmission cable 252. After that, the data source 250 obtains the position (x, y) pointed by the optical device 210 in the projection image 240 according to the position information S_{L} and moves the cursor 242 to the position (x, y) accordingly. Thus, a user may move the cursor 242 in the projection image 240 through the optical device 210.

In an embodiment of the invention, the optical device 210 further has an analog-to-digital converter (ADC) 216. The ADC 216 is coupled to the analog amplifier 214 for converting the amplified signal S_{A} into the detection signal S_{D}. The transmission module 218 is coupled to the ADC 216, and which transmits the detection signal S_{D} to the projector 220 in a wireless manner. In addition, the projector 220 includes a first wireless transmission module 222, an ADC 224, a processor 226, a signal processing module 228, a projection module 230, and a transmission interface 232. The first wireless transmission module 222 receives the detection signal S_{D} from the optical device 210. The ADC 224 is coupled to the first wireless transmission module 222 for converting the detection signal S_{D} into a digital signal S_{B}. The processor 226 is coupled to the ADC 224. The processor 226 processes the image signal S_{IM} and generates the position information S_{L} according to the digital signal S_{B}. The signal processing module 228 is coupled to the processor 226, and which combines the identification signal S_{I} into the image signal S_{IM} to generate the projection signal S_{P}. The projection module 230 is coupled to the signal processing module 228, and which projects the projection image 240 according to the projection signal S_{P}. The transmission interface 232 is coupled to the processor 226, and which transmits the position information S_{L} to the data source 250 through the transmission cable 252.

In an embodiment of the invention, the ADCs 216 and 224 may be MSP430 chips, the processor 226 may be a DDP2431 chip, and the transmission modules 218 and 222 may be CC2500 chips. Besides, the transmission interface 232 may be a universal serial bus (USB) interface, a video graphics array (VGA) interface, a high-definition multimedia interface (HDMI), or an S-video interface.

In an embodiment of the invention, the mode switching module 270 has a first button 211, a second button 213, a third button 215, and a fourth button 217. However, the number of buttons of the mode switching module 270 in the embodiment is only an example but not intended to limit the invention, and the mode switching module 270 may also have other number of buttons. In the embodiment, both the first button 211 and the fourth button 217 generate a first control signal S₁, the second button 213 generates a second control signal S₂, and the third button 215 generates a third control signal S₃. As described above, the mode switching module 270 controls the projector 220 to switch from the first mode to the second mode according to one or more of the first control signal S₁, the second control signal S₂, and the third control signal S₃. In an embodiment of the invention, the first mode may be a mouse mode, and the second mode may be a remote control mode. Namely, the optical device 210 is used as a mouse when the projector 220 is in the first mode and as a remote control when the projector 220 is in the second mode. When the projector 220 is in the mouse mode, the first button 211 and the second button 213 respectively work as the left and right button on a mouse. Namely, the first control signal S₁ and the second control signal S₂ are respectively equivalent to the conventional left button signal and right button signal of a mouse. When the projector 220 is in the remote control mode, the first button 211 and the second button 213 respectively work as the up and down buttons on a remote control. Namely, the first control signal S₁ and the second control signal S₂ are respectively equivalent to the up and down signals of a typical remote control.

As shown in FIG. 2, in an embodiment of the invention, the optical device 210 appears as a pen, and the fourth button 217 is disposed at the tip of the optical device 210. Thus, when the projector 220 is in the mouse mode, a user may bring the fourth button 217 of the optical device 210 into direct contact with the projection image 240 so that the optical device 210 may be used as a drawing pen to draw a graphics on the projection image 240 when a drawing program is executed. Additionally, in an embodiment of the invention, the third button 215 is used as a function button.

In an embodiment of the invention, when a user is about to switch the projector 220 from the first mode to the second mode or from the second mode to the first mode, the user may press the third button 215 for a predetermined time (for example, 3 seconds) to trigger the mode switching of the projector 220 between the first mode and the second mode. However, the method for switching the mode of the projector 220 is not limited thereto. For example, in another embodiment of the invention, a user may simultaneously press at least two of the first button 211, the second button 213, the third button 215, and the fourth button 217 to trigger the mode switching of the projector 220 between the first mode and the second mode.

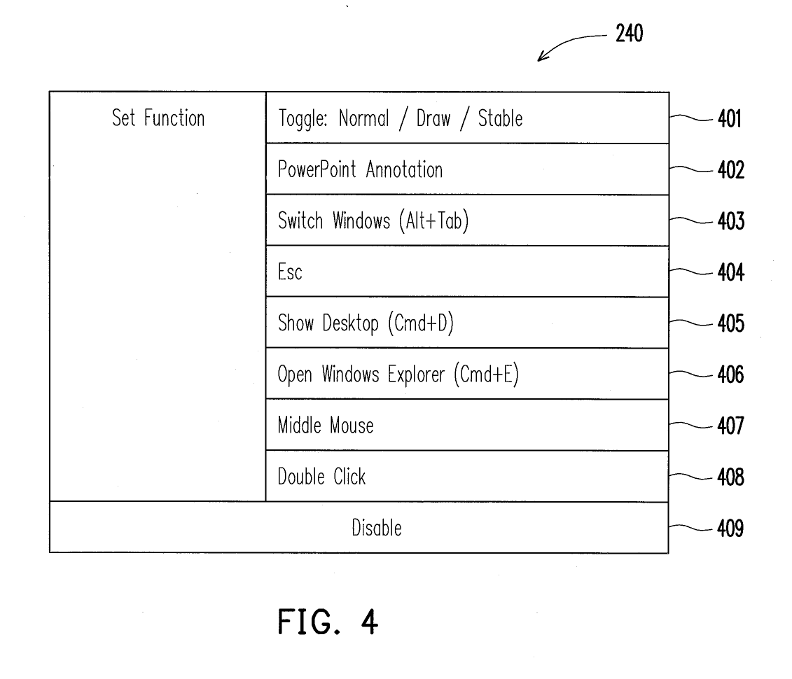

In an embodiment of the invention, when the projector 220 switches from the first mode to the second mode, a plurality of options are displayed on the projection image 240 such that the user may set a function corresponding to the third button 215. FIG. 4 is a diagram of the projection image 240 when a function corresponding to the third button 215 is set according to an embodiment of the invention. Referring to FIG. 4, options 401-409 are displayed on the projection image 240, and each option is corresponding to a function of the third button 215. Herein, the user selects one of the options 401-409 through the first button 211 and the second button 213 to set the function of the third button 215. In other words, the projection system 200 may set the function of the third button 215 through on screen display (OSD). Each of the options 401-409 is corresponding to a different function. For example, when the option 401 is selected, the third button 215 is used as a detection mode switch button for switching between different techniques for the receiving module 260 to sense the reflected signal of the projection image 240. When the option 402 is selected, the third button 215 is used as an annotation button in Microsoft® PowerPoint®. When the option 403 is selected, the third button 215 is used for switching between windows. When the option 404 is selected, the third button 215 is used as an ESC button. When the option 405 is selected, the third button 215 is used for displaying the desktop. When the option 406 is selected, the third button 215 is used for opening up the file explorer. When the option 407 is selected, the third button 215 is used as the middle button of the mouse. When the option 408 is selected, the third button 215 is used for triggering a double click of the mouse. When the option 409 is selected, the third button 215 is closed. Thus, the third button 215 may be set into different function buttons corresponding to different options 401-409.

Additionally, in an embodiment of the invention, the mode switching module 270 may have more buttons. For example, the mode switching module 270 may have up, down, left, right, enter, and menu buttons corresponding to those on a typical remote control. When a user presses the menu button, another OSD menu pops up in the projection image 240. This OSD menu includes (but is not limited to) the options for setting different characteristics (for example, brightness, chroma, color temperature, contrast, and white balance, etc) of the projection image 240. Thus, all the functions of a conventional remote control may be achieved by the optical device 210.

Moreover, because the optical device 210 locates and tracks the cursor 242 according to the identification signal S_{I} in the projection image 240, in an actual application, the accuracy in locating and tracking the cursor 242 is affected by the brightness of the projection image 240. The higher brightness the projection image 240 has, the more accurately the cursor 242 is located and tracked. Thus, in an embodiment of the invention, when the identification signal S_{I} collected by the receiving module 260 of the optical device 210 is not stable, the projector 220 automatically adjusts the brightness and contrast of the projection image 240 so as to provide a more stable operation environment to the user. To be specific, in such an embodiment, the receiving module 260 of the optical device 210 is also used for sensing the brightness of the projection image 240. The transmission module 218 transmits the brightness information related to the projection image 240 sensed by the optical device 210 to the projector 220 so that the projector 220 may automatically adjust the brightness of the projection image 240 according to the brightness information.

Referring to both FIG. 2 and FIG. 3, in an embodiment of the invention, the projector 220 further has a switch 236 for turning on the signal processing module 228.

When the switch 236 is turned on, the signal processing module 228 is turned on so that the signal processing module 228 combines the identification signal S_{I} into the image signal S_{IM} to generate the projection signal Sp. When the switch 236 is turned off, the signal processing module 228 is turned off so that the signal processing module 228 directly outputs the image signal S_{IM} to the projection module 230. Herein the projection signal Sp is equivalent to the image signal S_{IM} and does not contain the identification signal S_{I}, and the optical device 210 is used simply as a remote control.

In an embodiment of the invention, the processor 226 of the projector 220 stores an application program 234. When the projector 220 is connected to the data source 250, the data source 250 downloads the application program 234 from the processor 226 of the projector 220 and installs it. The data source 250 updates the information about the position (x, y) and the content of the image signal S_{IM} according to position information S_{L} by executing the application program 234. Accordingly, the cursor 242 in the projection image 240 moves according to the position (x, y) pointed by the optical device 210. In addition, in an embodiment of the invention, the application program 234 is stored in a storage device (not shown) outside of the processor 226, and the data source 250 downloads and installs the application program 234 from the storage device.

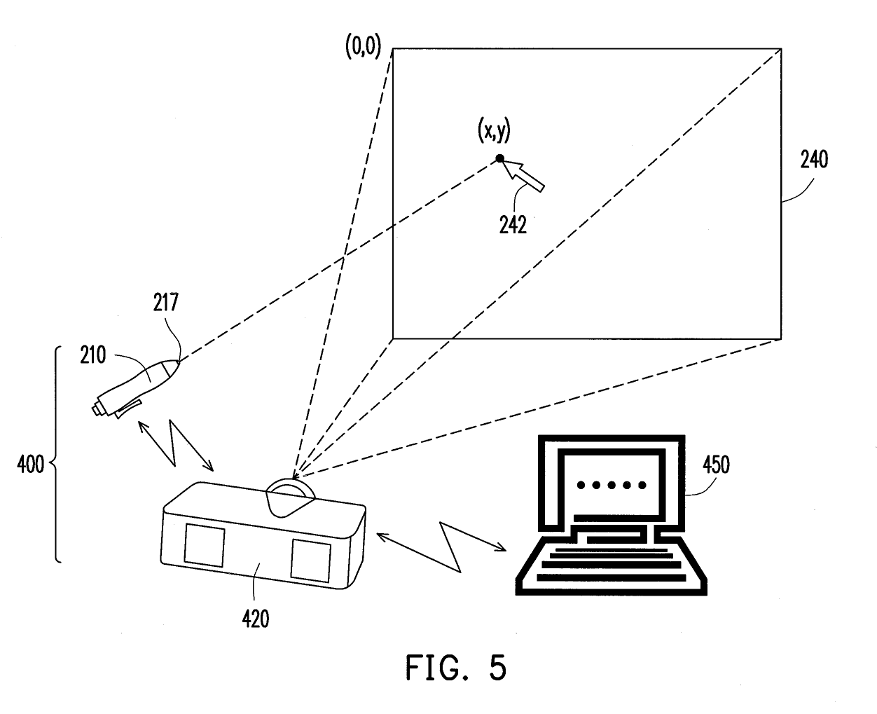

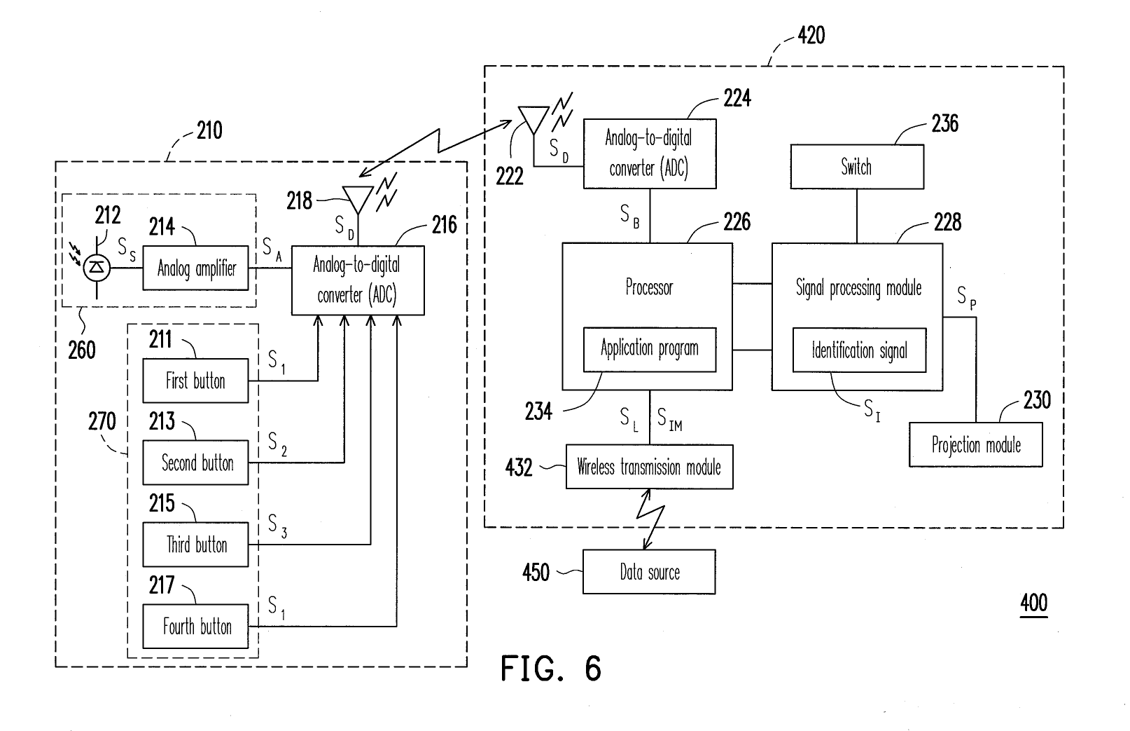

FIG. 5 is a diagram of a projection system 400 according to an embodiment of the invention, and FIG. 6 is a schematic block diagram of the projection system 400 in FIG. 5. Referring to FIG. 5 and FIG. 6, the projection system 400 has an optical device 210 for controlling a projector 420. The major difference between the projector 420 and the projector 220 is that the transmission interface 232 of the projector 220 is replaced by the wireless transmission module 432 of the projector 420. The projector 420 is connected to the data source 450 through the wireless transmission module 432 so as to receive the image signal S_{IM} from the data source 450 and transmit the position information S_{L} to the data source 450. In addition, components of the projection system 400 have the same functions as those of the projection system 200 therefore will not be described herein. Moreover, the transmission protocol adopted by the wireless transmission module 432 may be a wireless transmission protocol, such as IEEE 802.11, WiFi, Bluetooth, and WiMAX, etc.

In summary, an embodiment of the invention has at least one of following advantages or functions. The optical device in an embodiment of the invention controls a projector. The optical device senses an image projected by the projector and transmits the detection result to the projector, so that the projector may determine the position pointed by the optical device in the projected image according to the detection result. Thus, a cursor in the projection image moves along with different position pointed by the optical device in the projection image. In addition, the projection system in an embodiment of the invention includes a projector and an optical device. The optical device senses an image projected by the projector and transmits the detection result to the projector, so that the projector may determine the position pointed by the optical device in the projection image according to the detection result. Thus, a user may move a cursor in the projected image in a wireless manner, which makes it very convenient for the user to give a briefing. The optical device has a mode switching module. The mode switching module generates a control signal to control the projector to switch from a first mode to a second mode. The optical device may be used as either a mouse or a remote control according to the mode of the projector.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. An optical device capable of controlling a projector, wherein the projector is capable of projecting a projection image, the optical device comprising:
a receiving module capable of sensing a reflected signal of the projection image;
a mode switching module capable of generating a control signal to control the projector to switch from a first mode to a second mode; and
a transmission module capable of transmitting the reflected signal sensed by the receiving module and the control signal generated by the mode switching module to the projector.

2. The optical device according to claim 1, wherein the mode switching module comprises a plurality of buttons, and one of the buttons generates the control signal.

3. The optical device according to claim 2, wherein the projector switches from the first mode to the second mode when one or more of the buttons are pressed for a predetermined time.

4. The optical device according to claim 2, wherein the projector switches from the first mode to the second mode when at least two of the buttons are simultaneously pressed.

5. The optical device according to claim 1, wherein the optical device is used as a mouse when the projector is in the first mode, and the optical device is used as a remote control when the projector is in the second mode.

6. The optical device according to claim 1, wherein the projector is capable of receiving an image signal from a data source, combining an identification signal into the image signal to generate the projection signal, and projecting the projection image according to the projection signal.

7. The optical device according to claim 6, wherein the receiving module is capable of sensing the reflected signal of the projection image and outputting a detection signal related to the reflected signal, and the transmission module transmits the detection signal to the projector in a wireless manner, wherein the projector determines a position pointed by the receiving module in the projection image according to the detection signal so as to output a position information to the data source.

8. The optical device according to claim 7, wherein the optical device further comprises an analog-to-digital converter, and the receiving module comprises:
a photosensitive component capable of sensing the reflected signal and outputting a sensed signal; and
an analog amplifier coupled to the photosensitive component and capable of amplifying the sensed signal to generate an amplified signal;
wherein the analog-to-digital converter is coupled to the analog amplifier, and the analog-to-digital converter is capable of converting the amplified signal into the detection signal, and the transmission module is coupled to the analog-to-digital converter, and the transmission module transmits the detection signal to the projector in a wireless manner.

9. The optical device according to claim 8, wherein the photosensitive component is a photodiode.

10. A projection system, comprising:
a projector capable of projecting a projection image; and
an optical device, comprising:
a receiving module capable of sensing a reflected signal of the projection image;
a mode switching module capable of generating a control signal to control the projector to switch from a first mode to a second mode; and
a transmission module capable of transmitting the reflected signal sensed by the receiving module and the control signal generated by the mode switch module to the projector.

11. The projection system according to claim 10, wherein the mode switching module comprises a plurality of buttons, and one of the buttons generates the control signal.

12. The projection system according to claim 11, wherein the projector switches from the first mode to the second mode when one or more of the buttons are pressed for a predetermined time.

13. The projection system according to claim 11, wherein the projector switches from the first mode to the second mode when at least two of the buttons are simultaneously pressed.

14. The projection system according to claim 10, wherein the optical device is used as a mouse when the projector is in the first mode, and the optical device is used as a remote control when the projector is in the second mode.

15. The projection system according to claim 10, wherein the projector is capable of receiving an image signal from a data source, combining an identification signal into the image signal to generate the projection signal, and projecting the projection image according to the projection signal.

16. The projection system according to claim 15, wherein the receiving module is capable of sensing the reflected signal of the projection image and outputting a detection signal related to the reflected signal, and the transmission module transmits the detection signal to the projector in a wireless manner, wherein the projector determines a position pointed by the receiving module in the projection image according to the detection signal so as to output a position information to the data source.

17. The projection system according to claim 16, wherein the optical device further comprises an analog-to-digital converter, and the receiving module comprises:
a photosensitive component capable of sensing the reflected signal and outputting a sensed signal; and
an analog amplifier coupled to the photosensitive component and capable of amplifying the sensed signal to generate an amplified signal;
wherein the analog-to-digital converter is coupled to the analog amplifier, and the analog-to-digital converter is capable of converting the amplified signal into the detection signal, and the transmission module is coupled to the analog-to-digital converter, and the transmission module transmits the detection signal to the projector in a wireless manner.

18. The projection system according to claim 17, wherein the projector controls a brightness of the projection image according to the detection signal.

19. The projection system according to claim 16, wherein the projector comprises:
a first wireless transmission module capable of receiving the detection signal from the optical device;
an analog-to-digital converter coupled to the first wireless transmission module and capable of converting the detection signal into a digital signal;
a processor coupled to the analog-to-digital converter and capable of processing the image signal and generating the position information according to the digital signal;
a signal processing module coupled to the processor and capable of combining the identification signal into the image signal to generate the projection signal;
a projection module coupled to the signal processing module and capable of projecting the projection image according to the projection signal; and
a transmission interface coupled to the processor and capable of transmitting the position information to the data source through a transmission cable.

20. The projection system according to claim 16, wherein the projector comprises:
a first wireless transmission module capable of receiving the detection signal from the optical device;
an analog-to-digital converter coupled to the first wireless transmission module and capable of converting the detection signal into a digital signal;
a processor coupled to the analog-to-digital converter and capable of processing the image signal and generating the position information according to the digital signal;
a signal processing module coupled to the processor and capable of combining the identification signal into the image signal to generate the projection signal;
a projection module coupled to the signal processing module and capable of projecting the projection image according to the projection signal; and
a second wireless transmission module coupled to the processor and capable of transmitting the position information to the data source in a wireless manner and receiving the image signal from the data source.
